(19) United States
(12) Patent Application Publication
(10) Pub. No.: US 2011/0093333 A1
(43) Pub. Date: Apr. 21, 2011

(54) Method and System for Distributing Licensed Multimedia Files

(75) Inventors: Johan Hjelm, Tokyo (JP); Theo Gerrit Kanter, Ronninge (SE); Mattias Lidstrom, Stockholm (SE)

(73) Assignee: TELEFONAKTIEBOLAGET LM ERICSSON (PUBL), Stockholm (SE)

(21) Appl. No.: 12/990,237

(22) PCT Filed: Apr. 18, 2008
(86) PCT No.: PCT/SE2008/050444

§ 371 Date: Oct. 29, 2010

(51) Int. Cl. G06Q 30/00

(52) U.S. Cl. 705/14.49

(57) ABSTRACT

A distribution method and apparatus for distributing multimedia files from service providers (20) to subscribers (30) is described herein. A multimedia communication system (10) includes multiple service providers (20). Each service provider (20) includes a media server (22) and promotion server (26), where the promotion servers (26) of different service providers (20) inter-connect via a resale gateway(40). A promotion server (26) in a first service provider (20) monitors the inventory of multimedia files stored in the corresponding media server (22), identifies the multimedia files having at least one use requirement that satisfies a predetermined criteria, and promotes the identified multimedia files. The promotion server (26) may promote the identified multimedia files to subscribers (30A) of the first service provider(20A) using a weight-based approach. Alternatively or additionally, the promotion server (26) may promote the identified multimedia files to other service providers (20B) by offering the identified multimedia files to other service providers (20B) in the communication system (10) via the resale gateway (40).

### TECHNICAL FIELD

The present invention generally relates to licensed multimedia files available to subscribers of a service provider, and more particularly relates to promoting unsold multimedia files to subscribers and/or other service providers.

### BACKGROUND

Multimedia devices provide a user with access to information in various formats, such as video, audio, and/or text formats. A service provider generally sells multimedia files to subscribers of the service provider. Subscribers may purchase multimedia file(s) from the service provider for download to their electronic devices.

To accommodate the demand for multimedia files, a service provider typically maintains an inventory of multimedia files purchased from one or more vendors. Multimedia files purchased by a service provider for resale to subscribers may have one or more contractual use requirements specific to that service provider, such as an expiration date associated with the price and/or sale of the file. For example, a multimedia file purchased from a vendor may expire 6 months from the date of purchase, preventing the service provider from reselling the file to a subscriber after the expiration date. Alternatively, the vendor purchase price may vary depending on a price expiration date. For example, the service provider may receive a 20% discount off the purchase price if a certain number of the purchased copies are resold to subscribers by a predetermined date, but may receive no discount or a lesser discount after the predetermined date.

To market the multimedia files to the subscribers and to help manage the large volume of inventory, some service providers maintain recommendation lists for the subscribers. The recommendation lists suggest multimedia files available to the subscribers based on subscriber preferences. For example, the recommendation list for a country-western fan may include multiple John Wayne movies, and the recommendation list for a jazz fan may include multiple Miles Davis and John Coltraine songs. Thus, recommendation lists help promote the available multimedia files.

Recommendation lists are not linked to contractual use requirements. For example, the contractual use requirements for a music video may require that the service provider sell all copies of the music video to subscribers within 6 months of the purchase of the music video from the vendor. Beyond the expiration date, the unsold and expired copies cannot be resold. Thus, contractual use requirements generally limit the shelf life of the multimedia files. For this reason, the service providers estimate the future demand for the multimedia files, and purchase enough copies to meet the estimated demand. When the actual demand is less than the estimated demand, and when recommendation lists are not linked to the estimated demand, a service provider may be left with an unexpected surplus of multimedia files, which may result in lost profits.

Because contractual use requirements are generally service provider specific, and therefore, do not apply across service provider boundaries, and because recommendation lists do not consider contractual use requirements, there remains a need for improved distribution of multimedia files.

### SUMMARY

The present invention provides an improved distribution method and apparatus for distributing multimedia files from service providers to subscribers. An exemplary communication system includes multiple service providers, where each service provider includes a media server and a promotion server. The communication system further includes a resale gateway that interconnects the promotion servers of different service providers. The promotion servers monitor the inventory of multimedia files stored in the corresponding media server relative to one or more contractual use requirements, identify the multimedia files having at least one contractual use requirement that satisfies a predetermined criteria, and automatically promote the identified multimedia files based on the predetermined criteria.

In one embodiment, a promotion server may identify multimedia files that are about to expire and automatically promote the identified multimedia files to subscribers of the corresponding service provider. For example, the promotion server may revise a recommendation list of multimedia files to include or otherwise emphasize the identified multimedia files to encourage a subscriber to purchase the identified multimedia files. This improves the chances that the identified multimedia files will sell before the expiration date. In some embodiments, the recommendation list may further offer the subscriber a purchase incentive. For example, the recommendation list may offer the identified multimedia files at a discounted price.

In another embodiment, the promotion server automatically promotes the identified multimedia files to a second promotion server associated with a second service provider via the resale gateway. If the second service provider is interested in or has a need for the promoted multimedia files, the resale gateway manages or brokers the transfer of the rights and/or content of the multimedia files from the originating service provider to the second service provider. The second promotion server may then promote the identified multimedia files to subscribers of the second service provider.

By promoting unsold inventory based on contractual use requirements relative to predetermined criteria, the present invention enables service providers to recover some, if not all, of the cost for unsold inventory that would have been lost in conventional systems. Further, the present invention provides a system that automatically arranges promotion of multimedia files to current subscribers and/or to other service providers regardless of the underlying technology of each service provider.

### BRIEF DESCRIPTION OF THE DRAWINGS

FIG. 1 shows an exemplary communication system according to the present invention.

FIG. 2 shows an exemplary process implemented by a service provider according to the present invention.

FIG. 3 shows an exemplary process for promoting identified multimedia files according to the present invention.

FIG. 4 shows another exemplary process for promoting identified multimedia files according to the present invention.

FIG. 5 shows another exemplary communication system according to the present invention.

### DETAILED DESCRIPTION

Service providers maintain an inventory of a wide variety of multimedia files, such as video, audio, and/or text files, in a media server to make the files available to subscribers on demand. Subscribers may purchase and download selected files to their electronic devices. To ensure that the inventory of multimedia files stored in the media server meets subscriber demand, service providers purchase and store multiple copies of each multimedia file from one or more vendors. This requires that the service provider estimate the future demand for the multimedia files.

The multimedia files purchased from vendors typically have contractual use requirements that limit the use of the purchased files. Exemplary contractual use requirements may comprise Digital Rights Management (DRM), expiration dates that require all copies of a particular file to be resold to subscribers by a certain date or within a predetermined amount of time after purchase, etc. For example, the contractual use requirements for a music video may require that the service provider sell all copies of the music video to subscribers within 6 months of the purchase of the music video from the vendor. Beyond the expiration date, the unsold and expired copies cannot be resold. Thus, contractual use requirements generally limit the shelf life of the multimedia files. For this reason, the service providers estimate the future demand for the multimedia files, and purchase enough copies to meet the estimated demand. When the actual demand is less than the estimated demand, a service provider may be left with an unexpected surplus of multimedia files. Because the service provider cannot sell any of the surplus copies after the expiration date, and because the service provider already paid for the surplus copies, service provider profits may be reduced when the expired surplus exceeds some predetermined number.

The present invention solves this problem by providing a method and apparatus for distributing multimedia files based on contractual use requirements. The following describes the invention in terms of multimedia files that are about to expire. However, the present invention also applies to other contractual use requirements, e.g., contractual requirements that define promotional/sale time periods, blackout periods, etc. Further, the following describes the invention in terms of video files, but applies to any multimedia file, including video files, audio files, text files, or any combination thereof.

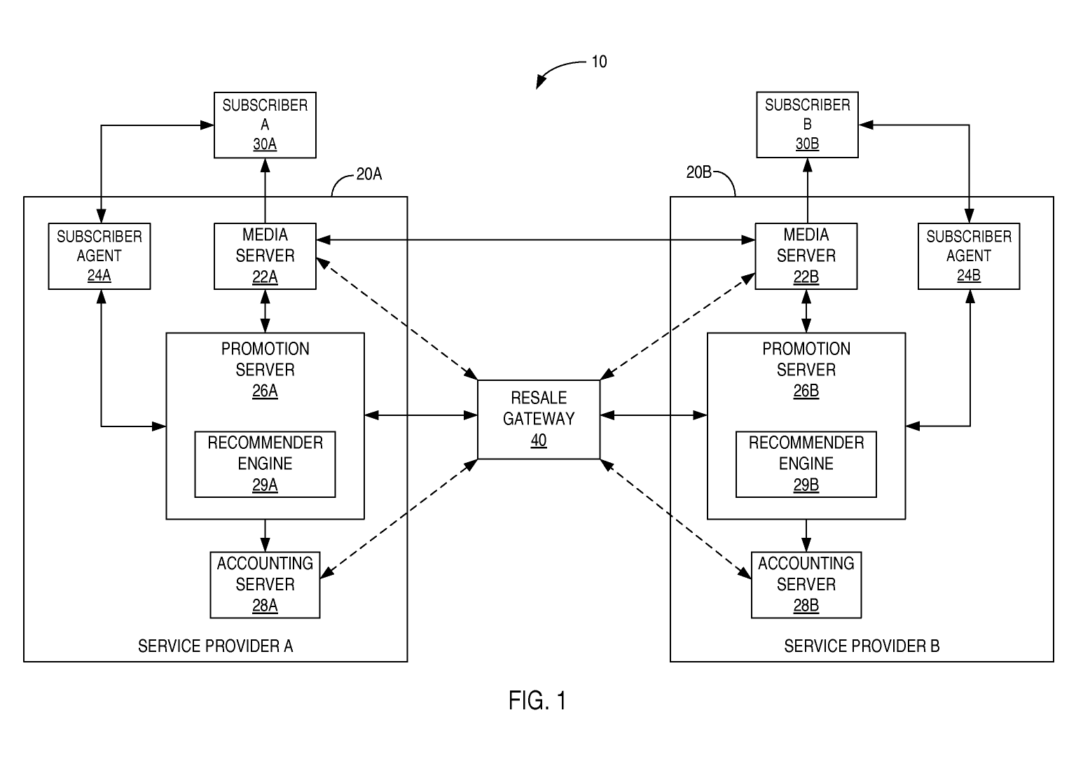

FIG. 1 shows an exemplary communication system 10 comprising multiple service providers 20. Communication system 10 may comprise any wired or wireless communication system, including but not limited to cellular, Bluetooth, IR, Ethernet, and USB communication systems. Service providers 20 provide video on demand to one or more subscribers 30. Each service provider 20 includes a media server 22, subscriber agent 24, promotion server 26, and accounting server 28. Media server 22 stores an inventory of video files available to the subscribers 30. In addition to interacting with the subscriber 30 via a user interface (e.g., a GUI interface), the subscriber agent 24 monitors and maintains subscriber profiles that include subscriber viewing preferences. The subscriber agent 24 reports the subscriber preferences to the promotion server 26. Promotion server 26 promotes video files in the media server 22 based on the subscriber preferences provided by the subscriber agent 24. In addition, the promotion server 26 of the present invention promotes video files based on contractual use requirements associated with the video files. For example, the promotion server 26 may add a music video having rights that are about to expire to a subscriber's recommendation list. Alternatively or additionally, the promotion server 26 may increase the importance of the music video within the subscriber's recommendation list, offer discounts, etc. Accounting server 28 keeps track of the video files purchased and resold by the service provider 20. The communication system 10 further includes a resale gateway 40 that interconnects the promotion servers 26 of each service provider 20, as discussed further below. Each service provider 20 subscribes to the resale gateway 40 before beginning operations in the communication system 10 to establish the inter-communication relationships and protocols necessary to communicate and transfer files.

Promotion server 26 includes a recommender engine 29 that constructs and maintains an ordered recommendation list of video files. The recommender engine 29 computes a compound weight for each item in the recommendation list based on a scaled combination of weight attributes. The compound weight corresponding to each item in a subscriber's recommendation list determines the order of the item within the recommendation list.

Exemplary weight attributes include but are not limited to attributes related to the time of year, genre, sales expiration dates, local events such as tours, etc. The service provider 20 typically assigns a set of weight attributes to each video file in the media server 22. For example, the service provider 20 may assign the following non-limiting set of weight attributes to a music video for a U2 song: popular music, international region, purchase expiration date, relevant decade, tour relevance, etc. By scaling each attribute according to relevant subscriber preferences, current events occurring in the subscriber's region, and current contractual use requirements, and subsequently combining the scaled weight attributes, the recommender engine 29 generates the compound weight for the music video.

According to the present invention, the recommender engine 29 selects a scaling coefficient for each weight attribute to emphasize/de-emphasize the corresponding weight attribute based on relevant factors, e.g., the subscriber's preferences, regional information, and/or contractual use requirements. For example, assume a particular subscriber 30 typically listens to or purchases 30% country music, 50% popular music, 10% Christmas music, and 10% regional music. In this example, the scaling coefficient for the country and pop music weight attributes may be 0.3 and 0.5, respectively, year round. Between Jan. and Oct., the scaling coefficient for the Christmas music weight attribute may be zero, while during Nov. and Dec., the Christmas music scaling coefficient may be set at some non-zero value, e.g., 0.5. During the months or weeks surround a particular regional musical event, the scaling coefficient for the regional weight attribute may increase for the multimedia files associated with the regional event. The recommender engine 29 of the present invention also considers contractual use requirements when selecting scaling coefficients. For example, as the expiration date for a particular video file approaches, the recommender engine 29 may increase a scaling coefficient corresponding to an expiration attribute to move the soon-to-expire video file higher on a subscriber's recommendation list.

In one exemplary embodiment, the recommender engine 29 may determine the compound weight for each item in a subscriber's recommendation list according to:

Wᵢ=W_{g}+W_{c}

W_{g}=c_{g,1}w_{g,1}+c_{g,2}w_{g,2}+ . . . +c_{g,n}w_{g,n}, (1)

W_{c}=c_{c,1}w_{c,1}+c_{c,2}w_{c,2}+ . . . +c_{c,m}w_{c,m}

where Wᵢ represents the compound weight for the i^{th} video file in the list, W_{g} represents the compound weight based on general weight attributes, w_{g,n} represents general weight attributes (e.g., genre, time of year, etc.), W_{c} represents the compound weight for contractual use attributes, and w_{c,m} represents the weight attributes for specific contractual use requirements (e.g., expiration date, promotion campaign, etc.). Equation (1) also relies on scaling coefficients c_{g,n} and c_{c,m}, which represent general and contractual scaling coefficients, respectively, for scaling the respective general and contractual weight attributes. To determine the general compound weight W_{g}, the recommender engine 29 determines the general scaling coefficients c_{g,n} based on the subscriber preferences provided by the subscriber agent 24, the date, regional activities, etc. For example, during December the recommender engine 29 may set a scaling coefficient corresponding to a Christmas video to a non-zero value. To determine the contractual compound weight W_{c}, the recommender engine 29 determines the contractual scaling coefficients c_{c,m} based on the importance of promoting the video file relative to different contractual use requirements. For example, if a particular video file stored in media server 22 is approaching an expiration date, the recommender engine 29 may set a scaling coefficient corresponding to the expiration date to a non-zero value. As the expiration date approaches, the recommender engine 29 may increase the scaling coefficient. Thus, the scaling coefficients enable the recommender engine 29 to implement a more elaborate weighting scheme than achievable with simple addition of the weight attributes. Further, unlike conventional service providers, the compound weight derived by the recommender engine 29 of the present invention considers both general and contractual attributes. Thus, recommender agent 29 enables the promotion server 26 to emphasize or de-emphasize various elements of the recommendation list based on more than just the general attributes of the files.

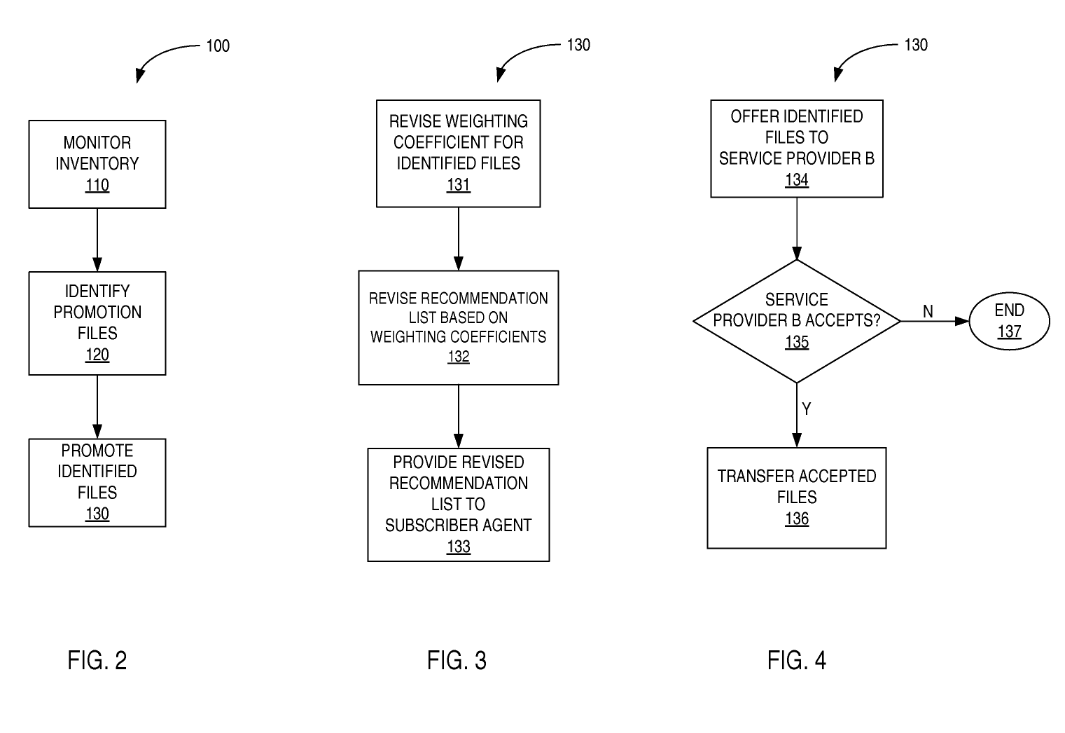

FIG. 2 shows an exemplary process 100 implemented by the promotion server 26A of one service provider 20A according to the present invention. Promotion server 26A monitors the inventory of video files stored in the media server 22A relative to one or more use requirements (block 110). The promotion server 26A identifies the video files having a contractual use requirement that satisfies a predetermined criteria (block 120). To improve the near-term sales of the identified files, the promotion server 26A automatically promotes the identified files (block 130). For example, while monitoring the rights expiration dates of the video file inventory, the promotion server 26A may identify five video files having rights that will soon expire e.g., within in two weeks. Alternatively or additionally, the video file inventory may include several video files that have price expiration dates linked to the number of copies sold by the service provider 20A. For example, the contract for a Seinfeld episode may include a 20% discount on the vendor sale price if a predetermined number of copies (e.g., 200 copies) are sold by the service provider 20A by a predetermined price expiration date. After the price expiration date, there may be no discount, or the discount may be reduced. Thus, the promotion server 26A may identify those video files having prices that will soon expire e.g., within one week. Regardless, due to the pending expiration date(s), promotion server 26A promotes the identified videos to subscribers in an attempt to sell as much of the unsold inventory before the expiration date(s). For example, recommender engine 29A of the promotion server 26A may add the identified videos to one or more recommendation lists and/or may modify the scaling coefficients associated with weight attributes for the identified videos.

FIG. 3 shows one exemplary promotion process 130 where promotion server 26A automatically promotes the identified video file(s) to current subscribers 30A. To promote the identified files, the recommender engine 29A adds the identified files to the recommendation list and/or revises the contractual scaling coefficients c_{c,m} corresponding to the promotion weight attributes w_{c,m} for the identified video(s) to revise the compound weights wᵢ of the affected videos in the subscriber's recommendation list (block 131). For example, the recommender engine 29A may increase one or more contractual scaling coefficients associated with an identified video file. Based on the revised compound weights, recommender engine 29A revises the order of the video files in the recommendation list (block 132). Additionally, the recommender engine 29A may revise the recommendation list to include an incentive for the subscriber to purchase the identified file. For example, the recommendation list may indicate that the identified file may be purchased at a reduced price. The promotion server 26A provides the revised list to the subscriber agent 24A (block 133), which presents the revised list to the subscriber 30A via the appropriate user interface. Because the identified video files are more heavily weighted, they are now higher in the subscriber's recommendation list, and therefore, more likely to be purchased by the subscriber 30A. As the contractual use requirements are met, e.g., the rights to the identified video files expire, the recommender engine 29A may again revise the scaling coefficients to reduce the emphasis on and/or remove the identified files.

In another exemplary promotion process 130 shown in FIG. 4, promotion server 26A automatically promotes the identified video file(s) to other service providers 20B via resale gateway 40. The promotion server 26A promotes the identified files to one or more service providers 20B in the communication system 10 via the resale gateway 40 (block 134). The promotion may stipulate the price and/or number of the promoted files. If a service provider 20B accepts the offer (block 135), the promotion server 26A transfers the rights to the accepted video files and/or the actual content of the accepted video files via resale gateway 40 (block 136). Further, the accounting servers 28A, 28B exchange accounting information via the resale gateway 40 based on the agreed upon price and number of transferred copies. Thus, the resale gateway 40 operates as a broker for unsold multimedia files facing a pending expiration date. Because the service providers 20 establish intercommunication relationships and protocols upon subscribing to the resale gateway 40, the resale gateway 40 enables the service providers 20 in communication system 10 to automatically discover promoted video files from other service providers 20, and to automatically establish relations on demand.

In one embodiment, promotion server 26A automatically transfers the rights to the video files to the receiving promotion server 26B to enable the receiving service provider 20B to resell the rights to a subscriber 30B. In this case, a subscriber 30B of the receiving service provider 20B receives the files from the originating service provider 20A after purchasing the rights to the video from the receiving service provider 20B. In another embodiment, promotion server 26A transfers the rights and the video files to the receiving promotion server 26B. Thus, subscriber 30B receives the video files from the receiving service provider 20B after purchasing the rights to the video files from the receiving service provider 20B.

Transferring video files between service providers 20A, 20B may require that the service providers 20A, 20B be under contract to enable the automatic exchange of multimedia files. In practice, this may be achieved, for example, by applying the same contractual transfer provisions to all service providers 20 in the communication system 10 when each service provider 20 subscribes to the resale gateway 40. Alternatively, if IMS is used to promote and transfer the identified multimedia files, existing IMS roaming and interoperability agreements may be implemented by the resale gateway 40. Thus, the resale gateway 40 enables the service providers 20 to automatically exchange files on demand without requiring the manual development of transfer protocols.

To illustrate the transfer process between service providers 20, consider the following example. The promotion server 26A in the offering service provider 20A promotes the identified videos to the promotion server 26B in the receiving service provider 20B via the resale gateway 40. A receiving service provider 20B evaluates the demand for the promoted videos by its subscribers 30B. If the receiving service provider 20B determines there is a current demand for the promoted files, promotion server 26B accepts the promoted files. The resale gateway 40 initiates the transfer by initiating a monetary settlement between the offering and receiving service providers 20A, 20B to reimburse the offering service provider 20A for the subsequent sales of the promoted files.

Resale gateway 40 subsequently transfers the rights of the accepted video files from the offering promotion server 26A to the receiving promotion server 26A. If appropriate, the transfer may involve key management and the transfer of DRM usage rights. For example, the original vendor may create the rights object for a video file being transferred and sign it with the appropriate key. In so doing, the vendor prevents tampering by other service providers 20 while still enabling the rights object to be read. The offering promotion server 26A then decrypts the created rights object with the original key and transfers the decrypted rights object to the receiving promotion server 26B. To prevent tampering, the transferred rights object may be signed using any means known in the art. Promotion server 26B encrypts the received rights object with a key assigned by the receiving service provider 20B. The receiving service provider 20B may now sell the rights to the video files to its subscribers 30B.

After completion of the rights transfer, the offering promotion server 26A may further transfer the contents of the accepted video files to the receiving promotion server 26B. The media server 22A in the offering service provider 20A then notifies the media server 22B of the receiving service provider 20B that the inventory is available, and the media server 22B notifies the recommender engine 29B of the available inventory. The recommender engine 29B then revises the recommendation list based on the newly transferred video files as discussed herein and sends the recommendation list to the subscriber agent 24B. The recommender engine 29B may revise the recommendation list either proactively or at the request of the subscriber 30B. In some cases, the list may include a notification indicating that the newly added videos are available at a discount. If the subscriber 30B requests a transferred video, the rights to the transferred video are delivered to the subscriber 30B according to any known means. The media server 22B and/or the promotion server 26B notify the accounting server 28B of the delivery. The accounting servers 28A, 28B exchange accounting information via the resale gateway 40 based on the agreed upon price and number of copies purchased by the subscriber 30B.

In still another exemplary embodiment, the promotion server 26A may implement the promotion processes of both FIGS. 3 and 4. For example, the promotion server 26A may first attempt to promote the identified video files to subscribers 30A of the corresponding service provider 20A according to FIG. 3. If this promotion fails, the promotion server 26A may attempt to promote the identified video files to other service providers 20B according to FIG. 4.

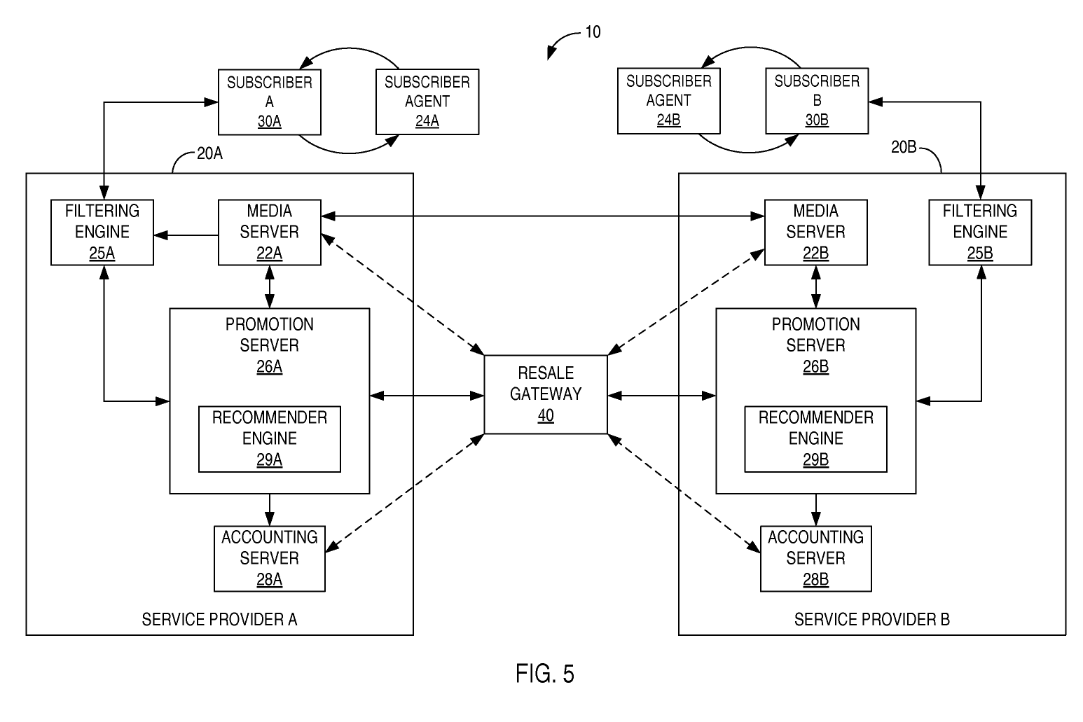

FIG. 5 shows an alternate communication system 10 where the subscriber agent 30 is not part of the service provider 20. Instead, each service provider 20 includes a filtering engine 25, and each subscriber 30 has a personal subscriber agent 24. The personal subscriber agents 24 update subscriber preferences based on a subscriber's use of the download service and/or based on subscriber specified preferences. The filtering engine 25 filters the recommendation list to the subscriber based on the subscriber preferences, the feedback from the subscriber agent 24, and the weighted offerings from the promotion server 26.

The present invention provides a method and apparatus for automatically promoting multimedia files to subscribers 30A of the corresponding service provider 20A and/or to subscribers 30B of other service providers. This enables a service provider 20 to sell unsold inventory before the inventory expires. Further, the present invention enables different service providers 20 to satisfy subscriber demand for particular multimedia files.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-25. (canceled)

26. A method implemented by a promotion server of a first service provider for distributing licensed multimedia files from that service provider, the method comprising:
monitoring an inventory of multimedia files available from the first service provider;
identifying at least one multimedia file within the inventory having at least one contractual use requirement that satisfies a predetermined criteria; and
promoting the identified multimedia files.

27. The method of claim 26 wherein promoting the identified multimedia files comprises promoting the identified multimedia files to a second service provider.

28. The method of claim 27 wherein promoting the identified multimedia files comprises offering the identified multimedia files to the second service provider.

29. The method of claim 28 further comprising transferring rights to the identified multimedia files to the second service provider.

30. The method of claim 28 wherein offering the identified multimedia files to the second service provider includes offering a purchase incentive for the identified multimedia files.

31. The method of claim 26 wherein promoting the identified multimedia files comprises promoting the identified multimedia files to one or more subscribers of the first service provider.

32. The method of claim 31 wherein promoting the identified multimedia files comprises offering a purchase incentive for the identified multimedia files to the subscribers of the first service provider.

33. The method of claim 31 wherein promoting the identified multimedia files comprises revising a recommendation list of multimedia files for at least one subscriber to include the identified multimedia files.

34. The method of claim 33 wherein revising the recommendation list comprises revising a compound weight associated with the identified multimedia files to emphasize the identified multimedia files within the recommendation list.

35. The method of claim 31 wherein promoting the identified multimedia files comprises revising a compound weight associated with the identified multimedia files to emphasize the identified multimedia files within a recommendation list.

36. The method of claim 35 wherein revising the compound weight comprises revising one or more scaling coefficients applied to one or more weight attributes used to calculate the compound weight.

37. The method of claim 35 wherein revising a compound weight comprises revising a compound weight associated with one or more contractual use requirements.

38. The method of claim 26 wherein the predetermined criteria comprises a predetermined time relationship, and wherein identifying multimedia files comprises identifying the multimedia files having an expiration date within the predetermined time relationship of the expiration date.

39. A communication system for distributing licensed multimedia files, the communication system comprising:
a plurality of service providers, each service provider comprising:
a media server configured to store licensed multimedia files;
a promotion server configured to:
monitor an inventory of the multimedia files stored in the media server;
identify multimedia files within the inventory having at least one contractual use requirement that satisfies a predetermined criteria; and
promote the identified multimedia files; and
a resale gateway configured to interconnect the promotion servers in said plurality of service providers.

40. The communication system of claim 39 wherein the promotion server is the promotion server of a first service provider in the communication system and is configured to promote the identified multimedia files by promoting the identified multimedia files to a second service provider in the communication system via the resale gateway.

41. The communication system of claim 40 wherein the promotion server promotes the identified multimedia files by offering the identified multimedia files to the second service provider via the resale gateway.

42. The communication system of claim 41 wherein the promotion server further transfers rights to the identified multimedia files to the second service provider.

43. The communication system of claim 41 wherein the promotion server further offers a purchase incentive for the identified multimedia files.

44. The communication system of claim 39 wherein the promotion server promotes the identified multimedia files by promoting the identified multimedia files to one or more subscribers of the corresponding service provider.

45. The communication system of claim 44 wherein the promotion server promotes the identified multimedia files by offering a purchase incentive for the identified multimedia files to the subscribers of the corresponding service provider.

46. The communication system of claim 44 wherein the promotion server comprises a recommender engine that promotes the identified multimedia files by revising a recommendation list of multimedia files for at least one subscriber to include the identified multimedia files.

47. The communication system of claim 46 wherein the recommender engine revises the recommendation list by revising a compound weight associated with the identified multimedia files to emphasize the identified multimedia files within the recommendation list.

48. The communication system of claim 44 wherein the promotion server comprises a recommender engine that promotes the identified multimedia files by revising a compound weight associated with the identified multimedia files to emphasize the identified multimedia files within a recommendation list.

49. The communication system of claim 48 wherein the recommender engine revises the compound weight by revising a compound weight associated with one or more contractual use requirements.

50. The communication system of claim 39 wherein the predetermined criteria comprises a predetermined time relationship, and wherein the promotion server identifies the multimedia file having an expiration date within the predetermined time relationship of the expiration date.
